(19) United States
(12) Patent Application Publication
(10) Pub. No.: US 2025/0358505 A1
(43) Pub. Date: Nov. 20, 2025

(54) INTELLIGENT SHOOTING CONTROL SYSTEM AND METHOD

(71) Applicant: Shenzhen Leqi Innovation Co., Ltd., Shenzhen (CN)

(72) Inventor: Wenming TANG, Zhongshan (CN)

(73) Assignee: Shenzhen Leqi Innovation Co., Ltd., Shenzhen, GD (CN)

(21) Appl. No.: 19/286,295

(22) Filed: Jul. 31, 2025

Related U.S. Application Data
(63) Continuation of application No. PCT/CN2023/116208, filed on Aug. 31, 2023.

(30) Foreign Application Priority Data
Feb. 8, 2023 (CN) 202310085007.7

(51) Int. Cl. H04N 23/61; H04N 23/66; H04N 23/667; H04N 23/71

(52) U.S. Cl. CPC H04N 23/61; H04N 23/66; H04N 23/667; H04N 23/71

(57) ABSTRACT

The present application discloses an intelligent shooting control system and method, belonging to the technical field of photography. The present application discloses an intelligent imaging control system comprising a trigger module and a control module connected in sequence. The control module is also connected to an external imaging device. The trigger module is configured to sense objects and generate trigger information to the control module; and the control module is configured to read the trigger information and generate a corresponding command according to the trigger information to control the external imaging device.

### CROSS-REFERENCE TO RELATED APPLICATIONS

The present application is a continuation application of PCT/CN2023/116208 filed on Aug. 31, 2023, which claims priority to Chinese Patent Application No. 202310085007.7, filed on Feb. 8, 2023, the entire contents of which are incorporated herein by reference.

### TECHNICAL FIELD

The present application relates to the technical field of photography, and more particularly to an intelligent shooting control system and method.

### BACKGROUND

Biodiversity serves as a critical indicator for assessing wilderness ecosystems, encompassing metrics such as plant species diversity, animal diversity, and key species viability indicators. Comprehensive evaluation of animal diversity requires not only population surveys but also long-term tracking and monitoring of wildlife activity patterns and behavioral changes. Automatic imaging devices have become essential tools for such research. Most operate via pyroelectric infrared sensors that detect animal heat signatures to automatically capture images/videos, enabling unmanned wildlife monitoring.

Capturing elusive and rarely sighted wildlife is the fervent aspiration of wildlife photographers. These animals are unpredictable in their movements, difficult to track, and exceptionally challenging to photograph.

Some fierce wild animals are difficult for photographers to approach, but wildlife photography enthusiasts still hope to capture them up close.

To achieve the aforementioned filming, infrared cameras are most often used as the filming device. However, the image clarity of infrared cameras often fails to meet user requirements, resulting in unsatisfactory filming results.

### SUMMARY

The main objective of the present application is to provide an intelligent shooting control system and method, designed to resolve the technical problem of unsatisfactory shooting effects in the existing technology, which makes it difficult to obtain high-definition images.

To achieve the aforementioned objective, the present application provides an intelligent shooting control system, comprising a trigger module and a control module connected in sequence, wherein the control module is connected to an external imaging device;
the trigger module is configured to sense objects and generate trigger information to the control module; and
the control module is configured to read the trigger information and generate a corresponding command according to the trigger information to control the external imaging device.

In one embodiment, the trigger information includes current information; when the trigger information is current information, the control module is configured to obtain a current differential based on the current information and compare the current differential with a preset current differential threshold; when the current differential is equal to or greater than the preset current differential threshold, the control module is configured to generate a start-shooting command to the external imaging device so as to control the external imaging device to start shooting; and
when the current differential is less than the preset current differential threshold, the control module is configured to generate a stop-shooting command to the external imaging device so as to control the external imaging device to terminate shooting.

In one embodiment, the control module and the external imaging device are connected via a connecting cable, the connecting cable comprised a shutter release cable and/or a USB data cable; and
the control module is further configured to retrieve a shooting mode and, based on the shooting mode and the start-shooting command, control the external imaging device via the shutter release cable and/or the USB data cable to perform video recording, single photo shooting, or continuous shooting.

In one embodiment, the control module communicates wirelessly with a terminal; and
the control module is further configured to issue an alert to the terminal based on the start-shooting command, so that the terminal controls the external imaging device according to the alert.

In one embodiment, the trigger module comprises a trigger unit, a main control unit, and a write unit connected in sequence, the main control unit and the write unit are respectively connected to the control module;
the trigger unit is configured to detect objects and generate sensing information to the main control unit; and
the main control unit is configured to generate trigger information to the write unit or the control module according to the sensing information; and
the write unit is configured to write object information for storage according to the trigger information.

In one embodiment, the trigger information includes work information, the work information is the information that the write unit writes to the object information based on the trigger information; and
the control module is further configured to generate a start-shooting command to the external imaging device according to the work information, so as to control the external imaging device to start shooting.

In one embodiment, the trigger information includes level signal information; and
the control module is further configured to generate a start-shooting command to the external imaging device when the level signal information is a preset level signal, so as to control the external imaging device to start shooting.

In one embodiment, the trigger module comprises at least one of the following: a pyroelectric infrared sensor unit, an infrared thermal imaging sensor unit, a camera target recognition unit, an ultrasonic detection unit, or a radar detection unit.

In one embodiment, the intelligent shooting control system comprises a light sensing module connected to the control module;
wherein the optical sensing module is configured to sense environmental information and send the environmental information to the control module; and
the control module is further configured to generate a sleep command to the external imaging device when the environmental information indicates nighttime, so as to deactivate the external imaging device.

Furthermore, to achieve the aforementioned objective, the present application provides an intelligent shooting control method applied to the intelligent shooting control system. The intelligent shooting control system comprises a trigger module and a control module, and the method comprises the following steps:
the trigger module detecting an object and generating trigger information to the control module; and
the control module reading the trigger information and generating a corresponding command based on the trigger information to control external imaging device.

In one embodiment, the step of the control module reading the trigger information and generating a corresponding command based on the trigger information to control external imaging device, comprises:
the control module reading the trigger information and calculating a current differential when the trigger information is current information;
comparing the current differential with a preset current differential threshold;
generating a start-shooting command to the external imaging device when the current differential is greater than or equal to the preset current differential threshold so as to start shooting; and
generating a stop-shooting command to the external imaging device when the current differential is less than the preset current differential threshold so as to terminate shooting.

In one embodiment, after the step of generating a start-shooting command to the external imaging device when the current differential is greater than or equal to the preset current differential threshold so as to start shooting, the method further comprises:
retrieving the shooting mode;
controlling the external imaging device to execute shooting according to the shooting mode;
when the shooting mode is video recording, triggering a shutter of the external imaging device to start recording, and re-triggering the shutter to terminate recording when the current differential falls below the preset current differential threshold, thereby completing video recording;
when the shooting mode is single photo shooting, triggering the shutter at intervals of a first preset period to complete single photo shooting; and
when the shooting mode is continuous shooting, triggering the shutter at intervals of a second preset period for a preset continuous shooting duration to complete continuous shooting.

In one embodiment, after the step of generating a stop-shooting command to the external imaging device when the current differential is less than the preset current differential threshold so as to terminate shootings, the method further comprises:
acquiring a duration during which the current differential remains below the preset current differential threshold; and
controlling the trigger module to stop detecting when the duration exceeds a preset detection time threshold.

Furthermore, to achieve the aforementioned objective, the present application provides an intelligent shooting control method for an intelligent shooting control system, wherein the intelligent shooting control system comprises a trigger module and a control module connected in sequence, and the control module is connected to an external imaging device; the method comprising the following steps:
the trigger module detecting an object and generating trigger information to the control module; and
the control module reading the trigger information and generating a corresponding command based on the trigger information to control external imaging device;
wherein the command comprises a start-shooting command and a stop-shooting command.

In one embodiment, when the start-shooting command is generated to the external imaging device, the method further comprises the following steps:
retrieving a shooting mode of the external imaging device; and
controlling the external imaging device to execute shooting according to the shooting mode.

In one embodiment, when the control module reads current information as the trigger information, the method further comprises the following steps:
the control module obtaining a current differential based on the current information, and comparing the current differential with a preset current differential threshold;
when the current differential is greater than or equal to the preset current differential threshold, the control module generating the start-shooting command to the external imaging device so as to control the external imaging device to start shooting; and
when the current differential is less than the preset current differential threshold, the control module generating the stop-shooting command to the external imaging device to control the external imaging device to stop shooting, or the control module generating a standby command to the external imaging device to control the external imaging device to standby.

In one embodiment, the method comprising the following steps:
acquiring a duration during which the current differential remains below the preset current differential threshold; and
controlling the trigger module to stop detecting when the duration exceeds a preset detection time threshold.

In one embodiment, in the step of controlling the external imaging device to execute shooting according to the shooting mode,
when the shooting mode is video recording, triggering a shutter of the external imaging device to start recording, and re-triggering the shutter to terminate recording when the current differential falls below the preset current differential threshold, thereby completing video recording;
when the shooting mode is single photo shooting, triggering the shutter at intervals of a first preset period to complete single photo shooting; and
when the shooting mode is continuous shooting, triggering the shutter at intervals of a second preset period for a preset continuous shooting duration to complete continuous shooting.

In one embodiment, when the control module reads level signal information as the trigger information, if the level signal information matches a preset level signal, the control module generates the start-shooting command to control the external imaging device; and the preset level signal is a high-level signal or a low-level signal.

In one embodiment, the trigger information includes work information, which confirms that the trigger module is writing detected object information through a predefined writing protocol; the method further comprises the following steps:
if the control module reads work information, generating the start-shooting command to the external imaging device to control the external imaging device to start shooting;
if the control module does not read working information, generating the stop-shooting command to the external imaging device to controls the external imaging device to stop shooting.

The present application discloses an intelligent imaging control system comprising a trigger module and a control module connected in sequence. The control module is also connected to an external imaging device. The trigger module is configured to sense objects and generate trigger information to the control module; and the control module is configured to read the trigger information and generate a corresponding command according to the trigger information to control the external imaging device. By quickly detecting an object through the trigger module, trigger information is generated to the control module, so that the control module obtains the work state of the trigger module according to the trigger information, and generates a corresponding command to control the external imaging device to shoot or stop shooting. Through the above method, the control module can quickly and accurately determine whether an object exists according to the trigger information, and can accurately control the external imaging device to shoot high-definition object information, thereby improving the shooting effect and obtaining high-definition images.

### BRIEF DESCRIPTION OF THE DRAWINGS

FIG. 1 is a schematic structural diagram of the first embodiment of the intelligent shooting control system of the present application;

FIG. 2 is a structural schematic diagram of the second embodiment of the intelligent shooting control system of the present application;

FIG. 3 is a flowchart illustrating the first embodiment of the intelligent shooting control method of the present application; and

FIG. 4 is a flowchart illustrating the second embodiment of the intelligent shooting control method of the present application.

Explanation of accompanying drawing reference numerals:

| No. | Name | No. | Name |
|---|---|---|---|
| 1 | Intelligent shooting Control | 30 | Light Sensing Module |
| | System | | |
| 10 | Trigger Module | 40 | Power Supply Module |
| 101 | Trigger Unit | 2 | External Imaging Device |
| 102 | Main Control Unit | 3 | Connecting cable |
| 103 | Write Unit | 4 | Terminal |
| 20 | Control Module | | |

The realization of the purpose, functional characteristics, and advantages of this application will be further described in conjunction with the embodiments and with reference to the accompanying drawings.

### DESCRIPTION OF THE EMBODIMENTS

It should be understood that the specific embodiments described herein are only used to explain the present application and are not intended to limit the present application.

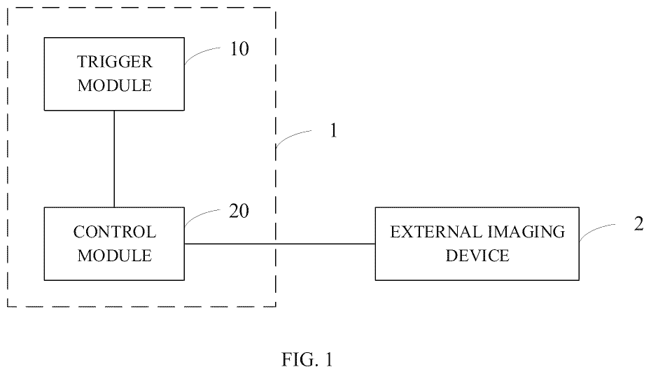

Referring to FIG. 1, FIG. 1 is a schematic structural diagram of a first embodiment of an intelligent shooting control system of the present application.

In this embodiment, the intelligent shooting control system 1 includes a trigger module 10 and a control module 20 connected in sequence, and the control module 20 is also connected to an external imaging device 2.

It should be noted that the trigger module 10 can be one or more of the following: a pyroelectric infrared sensor unit, an infrared thermal imaging sensor unit, a camera target recognition unit, an ultrasonic detection unit, or a radar detection unit, such as an infrared sensor, an infrared pyroelectric sensor, or an infrared camera, etc. This embodiment does not impose any limitation in this regard. The trigger module 10 is a module capable of detecting information emitted by humans or animals, such as infrared rays, ultrasonic waves, etc., thereby outputting electrical signals.

In a specific embodiment, the trigger module 10 is connected to the control module 20. The trigger module 10 is configured to detect objects and generate trigger information to the control module 20.

When the trigger module 10 senses the appearance of an object, it generates trigger information and transmits the trigger information to the control module 20 connected to it.

In a specific embodiment, the trigger information may include level signal information, current information, work information, or other information, which is not limited in this embodiment. For example, if the trigger module 10 is an infrared camera, when the infrared camera detects an object, the infrared pyroelectric sensor of the infrared camera will generate level signal information, and the main control board of the infrared camera will generate current information; or upon detecting an object, the infrared camera captures the object and writes the acquired object information as the work information, the control module 20 reads the level signal information, the current information, or the work information generated by the infrared camera, and generates a corresponding command to control the external imaging device 2.

It should be understood that the control module 20 is configured to read the trigger information and generate corresponding commands to the external imaging device 2 according to the trigger information, so as to control the external imaging device 2.

In a specific embodiment, the other end of the control module 20 is connected to the external imaging device 2. The control module 20 can be equipped with an information-reading module, which can be arranged close to or installed on the trigger module 10 to read the trigger information of the trigger module 10. The control module 20 can also be integrated inside the trigger module 10, so as to directly receive the trigger information transmitted by the trigger module 10 and generate a corresponding command to control the external imaging device 2. The system may comprise one or multiple external imaging devices 2, which may include digital cameras of identical models, different models, or distinct shooting types, such as cameras for daytime shooting and cameras for nighttime shooting, etc. The commands can be a start-shooting command or a stop-shooting command, etc., and can also be a standby (sleep) command, a command to turn off the shooting of one external imaging device 2 and switch to another external imaging device 2 to start shooting, etc.

In a specific embodiment, when the control module 20 reads current information as the trigger information, and the current information includes the present current information of the trigger module 10 and the standby current information of the trigger module 10. It can be determined whether the trigger module 10 detects an object through the current information, that is, whether the trigger module 10 is working. When it is determined that the trigger module 10 detects an object, the control module 20 generates a start-shooting command to the external imaging device 2. When it is determined that the trigger module 10 does not detect an object, the control module 20 generates a stop-shooting command to the external imaging device 2.

When the trigger information is level signal information, for example, when the level signal matches a preset level signal, the control module 20, upon reading the preset level signal, generates a start-shooting command to control the external imaging device 2. The preset level signal can be a high-level signal or a low-level signal.

If the control module 20 reads work information as the trigger information, it thereby confirms that the trigger module 10 is actively writing detected object information through a predefined writing protocol. That is, it can determine the existence of the object sensed by the trigger module 10, and the control module 20 generates a start-shooting command to the external imaging device 2.

In this embodiment, when the trigger information is current information, the control module 20 is further configured to obtain a current differential based on the current information, and compare the current differential with a preset current differential threshold. When the current differential is greater than or equal to the preset current differential threshold, a start-shooting command is generated to the external imaging device 2 to control the external imaging device 2 to start shooting.

The external imaging device 2 is a device capable of shooting high-definition images or videos, such as digital cameras of different brands, full-color night vision cameras, etc., and can also be other cameras capable of shooting high-definition images or videos. This embodiment imposes no limitation in this regard.

The control module 20 is further configured to generate a stop-shooting command to the external imaging device 2 when the current differential is less than the preset current differential threshold, so as to control the external imaging device 2 to stop shooting.

It should be understood that the preset current differential threshold can be set by itself according to requirements, for example, the preset current differential threshold is 275 mA, 400 mA, etc. This embodiment imposes no limitation in this regard. The current differential refers to the current differential between the current of the trigger module 10 in the standby state and the current of the working trigger module 10. For example, the current of the trigger module 10 in the standby state is 50 microamps, the current when working during the day is 280 mA, and the maximum current when working during the night is 850 mA. By setting a preset current differential threshold, the current information during work and the current in the standby state are calculated, and the calculated current differential is compared with the preset current differential threshold. When the current differential is greater than or equal to the preset current differential threshold, it proves that the trigger module 10 is working at this time and is in a state of detecting the presence of an object. After the control module 20 reads this information, it generates a start-shooting command to the external imaging device 2, and the external imaging device 2 can be controlled to shoot the object through the start-shooting command. The detected object is photographed by the external photographing device 2, which improves the high-definition effect of the photographing, thereby improving the photographing experience and obtaining satisfactory image data.

In a specific embodiment, when the current differential is less than the preset current differential threshold, it proves that the trigger module 10 has not detected an object at this time, that is, it is in the standby state or a state of stopping sensing. Then, a stop-shooting command can be generated to the external imaging device 2 to control the external imaging device 2 to stop shooting, or a standby command can be generated to the external imaging device 2 to control the external imaging device 2 to standby.

This embodiment provides an intelligent shooting control system in which a trigger module and a control module are sequentially connected, and the control module is also connected to an external imaging device; the trigger module is configured to sense an object and generate trigger information to the control module; and the control module is configured to read the trigger information and generate a corresponding command according to the trigger information to control the external imaging device. By quickly sensing an object through the trigger module to generate trigger information to the control module, the control module acquires the work state of the trigger module according to the trigger information, and generates a corresponding command to control the external imaging device to shoot or stop shooting. Through the above method, the control module can quickly and accurately determine whether an object exists based on the trigger information, and can accurately control the external imaging device to shoot high-definition object information, thereby improving the shooting effect and obtaining high-definition images.

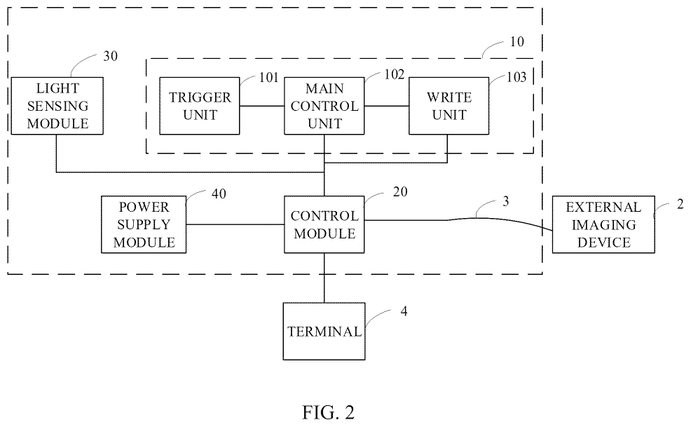

Referring to FIG. 2, FIG. 2 is a schematic structural diagram of the second embodiment of the intelligent shooting control system of the present application.

In this embodiment, the control module 20 and the external imaging device 2 are connected via a connecting cable 3, the connecting cable 3 includes a shutter release cable and/or a USB data cable; the control module 20 is further configured to retrieve a shooting mode, and based on the shooting mode and the start-shooting command, control the external imaging device 2 via the shutter release cable and/or the USB data cable to perform video recording, single photo shooting, or continuous shooting.

It should be understood that the control module 20 is connected to the external imaging device 2 via the connecting cable 3. The connecting cable 3 can be a separate shutter release cable or a separate USB data cable capable of sending commands, or it can be connecting cables with both a shutter release cable and a USB data cable connected; the corresponding command is sent through the shutter release cable, the USB data cable, or the combined action of the shutter release cable and USB data cable to quickly control the external imaging device 2. The control module 20 has internally configured logic for the shooting mode, which can be used to set the shooting mode of the external imaging device 2 in advance and store it in the control module 20. When shooting is required, the control module 20 can retrieve the shooting mode by itself, and perform corresponding shooting on the external imaging device through the shooting mode and the start-shooting command through the connecting cable 3, such as video recording, single photo shooting, or continuous shooting, etc. When the control module 20 generates a start-shooting command, it can control the external imaging device 2 to perform automatic shooting.

In this embodiment, the trigger module 10 includes a trigger unit 101, a main control unit 102, and a write unit 103 connected in sequence, and the main control unit 102 and the write unit 103 are respectively connected to the control module 20.

It should be understood that the trigger unit 101 can be an infrared pyroelectric sensing trigger unit, an infrared thermal imaging sensing trigger unit, a camera target recognition trigger unit, an ultrasonic detection trigger unit, or a radar detection trigger unit. The trigger unit 101 detects objects to generate sensing information to the main control unit 102. The sensing information can be level signals, current signals, or work signals, and can also be other sensing information.

The main control unit 102 is configured to generate the trigger information to the write unit 103 or the control module 20 according to the sensing information.

In a specific embodiment, the main control unit 102 can be connected to the control module 20, and generate the trigger information to be transmitted to the control module 20, so that the control module 20 controls the external imaging device 2 according to the trigger information. The main control unit 102 can also be integrated with the control module 20 into a single control unit, and the integrated control unit directly controls the external imaging device 2. The control module 20 or the integrated control unit can read the work information of the write unit 103. When it is read that the write unit 103 is performing the writing operation of the object information, it is determined that the trigger module 10 detects an object at this time, and a start-shooting command is generated to perform shooting control on the external imaging device 2.

The write unit 103 is configured to write object information for storage according to the trigger information. The trigger information includes work information, which is the information used by the write unit 103 to write object information according to the trigger information. The control module 20 is further configured to generate a start-shooting command to the external imaging device 2 according to the work information, so as to control the external imaging device 2 to start shooting.

It should be understood that the write unit 103 is configured to acquire the object information sensed by the trigger unit 101 in the trigger module 10 after receiving the trigger information, and write the object information through the predetermined writing protocol to be stored in the internal storage card. When the write unit 103 writes the object information, the control module 20 reads work information, and then generates a start-shooting command to the external imaging device 2 to control the external imaging device 2 to start shooting. When the control module 20 does not read working information, it generates a stop-shooting command to the external imaging device 2, and controls the external imaging device 2 to stop shooting.

In a specific embodiment, the intelligent shooting control system 1 further includes a light sensing module 30. The light sensing module 30 is connected to the control module 20. The light sensing module 30 is configured to sense environmental information and send the environmental information to the control module 20. The control module 20 is further configured to generate a sleep command to the external imaging device 2 when the environmental information indicates nighttime, so as to control the external imaging device 2 to enter sleep mode.

It should be understood that the light sensing module 30 can be a light intensity sensor, such as a photodiode, or other devices capable of sensing light intensity. This embodiment does not impose any imposes no limitation in this regard. The light sensing module 30 senses external environmental information, specifically including information of daytime or nighttime. It determines whether the present environment is daytime or nighttime by sensing the light intensity and sends the environmental information to the control module 20. The light sensing module 30 can be connected to the control module 20 separately, or it can be integrated inside the trigger module 10 or installed separately outside the intelligent shooting control system 1. This embodiment does not impose any imposes no limitation in this regard. When the environmental information indicates nighttime, the control module 20 generates a sleep command to the external imaging device 2, controlling the external imaging device 2 to sleep. Simultaneously, the control module 20 itself enters a sleep state. At this time, the trigger module 10 can continue to work, and the trigger module 10 can function as an independent camera to sense and shoot objects, obtaining image data.

In this embodiment, a display device may also be integrated on the intelligent shooting control system 1 or a display device may be externally provided. The display device is integrated or externally mounted on the intelligent shooting control system 1, such as a liquid crystal display screen. The display device is connected to the control module 20, and a sleep time of the control module 20 and the external imaging device 2 is manually set on the display device and displayed on the display screen. When the set sleep time is reached, the control module 20 generates a sleep command to the external imaging device 2 according to the information obtained from the display device, controls the external imaging device 2 to sleep, and simultaneously controls the control module 20 itself to enter the sleep state. The display device can also display the shooting mode set inside the control module 20. When the control module 20 performs shooting control on the external imaging device 2, the display device can display the present shooting mode on the display screen.

In a specific embodiment, the intelligent shooting control system further includes a power supply module 40, the power supply module 40 is connected to the control module 20; and the power supply module 40 is configured to provide power to the control module 20.

It should be noted that the power supply module 40 can be an external charging power source or a DC power supply, and can also be a battery power source set inside the control module 20. This embodiment does not impose any imposes no limitation in this regard. The power supply module 40 can be connected to the control module 20 to provide power to the control module 20. The power supply module 40 can also supply power to the trigger module 10, the light sensing module 30, and the external imaging device 2. For example, the external imaging device 2 can be connected to a power supply end of the control module 20 through a battery converter or a USB connecting cable, so that the control module 20 receives the power from the power supply module 40 and provides the power to the external imaging device 2 for power supply, so that the external imaging device 2 can continue to work.

In a specific embodiment, the control module 20 also communicates wirelessly with a terminal 4; the control module 20 is further configured to generate an alert to the terminal 4 according to the start-shooting command, so that the terminal 4 controls the external imaging device 2 according to the alert.

It should be understood that the terminal 4 can be a mobile phone, tablet computer, or other devices. The control module 20 and the terminal 4 can be wirelessly connected via Bluetooth or Wi-Fi, so that the control module 20 can send information to the terminal 4 and also receive information sent by the terminal 4. For example, when the trigger information is current information, and the current differential is greater than or equal to a preset current differential threshold, the control module 20 controls the external imaging device 2 to enter an automatic shooting state according to the start-shooting command. At the same time, the control module 20 generates an alert according to the start-shooting command and sends the alert to the terminal 4, prompting the terminal 4 that an object has appeared at this time. The method of alerting can be vibration or voice prompt from the terminal 4. When the terminal 4 receives the alert, the user can choose whether to control the external imaging device 2 according to the alert. The user can operate on the operation interface of the terminal, for example, the user clicks to cancel automatic shooting mode and enters the state of manual operation to stop automatic shooting. If the user does not operate the interface of the terminal, the external imaging device 2 continues to be controlled for automatic shooting. The trigger information may also include a level signal. When the level signal is a preset level signal, for example, the preset level signal is a high level signal or a low level signal, the control module 20 generates a start-shooting command to control the external imaging device 2, and simultaneously generates an alert to the terminal 4, or the control module 20 reads the work information of the write unit 103, and then generates a start-shooting command to control the external imaging device 2, and simultaneously generates an alert to the terminal 4.

It should be noted that when the automatic shooting state is paused, the terminal 4 cannot restore the automatic shooting state of the external imaging device 2. After the user stops controlling the external imaging device 2, the external imaging device 2 enters the standby state. When the control module 20 receives the trigger information again and determines that an object appears based on the trigger information, the external imaging device 2 enters the automatic shooting state.

In this embodiment, the control module is connected to the external imaging device through a connecting cable, which includes a shutter release cable and/or a USB data cable; the control module is further configured to retrieve a shooting mode, and through the shooting mode and the start-shooting command, the external imaging device is controlled to perform video recording, single photo shooting, or continuous shooting through the shutter release cable and/or the USB data cable. The control module can control the external imaging device according to the shooting mode when starting shooting, which improves the flexibility and control effect of shooting, and thus enhances the intelligence of shooting.

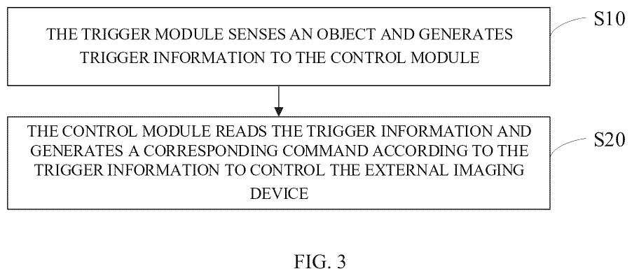

This embodiment of the present application provides an intelligent shooting control method. Referring to FIG. 3, FIG. 3 is a schematic flowchart of a first embodiment of the intelligent shooting control method of the present application.

In this embodiment, the intelligent shooting control method is applied to the intelligent shooting control system described above, which includes a trigger module and a control module. The intelligent shooting control method includes the following steps:

Step S10, the trigger module senses an object and generates trigger information to the control module.

It should be noted that the trigger module can be one or more of the following: a pyroelectric infrared sensor unit, an infrared thermal imaging sensor unit, a camera target recognition unit, an ultrasonic detection unit, or a radar detection unit, such as an infrared sensor or a pyroelectric infrared sensor, and can also be an infrared camera, etc. This embodiment does not impose any limitation in this regard. The trigger module is a module that can detect information emitted by humans or animals, such as infrared rays and ultrasonic waves, thereby outputting electrical signals.

In a specific embodiment, the trigger module is connected to the control module. The trigger module is configured to sense an object and generate trigger information to the control module.

When the trigger module detects the appearance of an object, it generates trigger information and transmits the trigger information to the control module connected to it. The trigger information may include level signal information, current information, work information, or other information, which is not limited in this embodiment. For example, if the trigger module is an infrared camera, it will generate current information when the infrared camera detects an object. Or, after the infrared camera detects an object and photographs it, it writes the photographed object information into the work information, and the control module can read the current information or the work information generated by the infrared camera.

Step S20, the control module reads the trigger information and generates a corresponding command according to the trigger information to control the external imaging device.

In a specific embodiment, the other end of the control module is connected to an external imaging device. The control module can be equipped with an information-reading module, and it can be placed near or installed on the trigger module to read the trigger information of the trigger module. The control module can also be integrated inside the trigger module, so as to directly receive the trigger information transmitted by the trigger module and generate a corresponding command to control the external imaging device. The command can be a start-shooting command or a stop-shooting command, etc., and can also be a standby (sleep) command, etc.

In a specific embodiment, if the control module reads current information as the trigger information, and the current information includes the present current information of the trigger module and the standby current information of the trigger module. It can be determined whether the trigger module detects an object through the current information, that is, whether the trigger module is working. When it is determined that the trigger module detects an object, the control module generates a start-shooting command to the external imaging device. When it is determined that the trigger module does not detect an object, the control module generates a stop-shooting command to the external imaging device.

If the trigger information read by the control module is work information, then the trigger module is currently writing the sensed object information through the predetermined writing protocol, which can determine the existence of the object detected by the trigger module, and the control module generates a start-shooting command to the external imaging device.

The external imaging device is a device capable of shooting high-definition images or videos, such as digital cameras of different brands, full-color night vision cameras, etc., and can also be other cameras capable of shooting high-definition images or videos. This embodiment does not impose any limitation in this regard.

In this embodiment, the intelligent shooting control system includes a trigger module and a control module connected in sequence; and the control module is also connected to an external imaging device. The trigger module is configured to sense an object and generate trigger information to the control module. The control module is configured to read the trigger information and generate a corresponding command based on the trigger information to control the external imaging device. By quickly sensing an object and generating trigger information through the trigger module, the control module can obtain the work state of the trigger module based on the trigger information and generate a corresponding command to control the external imaging device to start shooting or stop shooting. Through the above method, the control module can quickly and accurately determine the existence of an object based on the trigger information, and accurately control the external imaging device to capture high-definition object information, thereby improving the shooting effect and obtaining high-definition images.

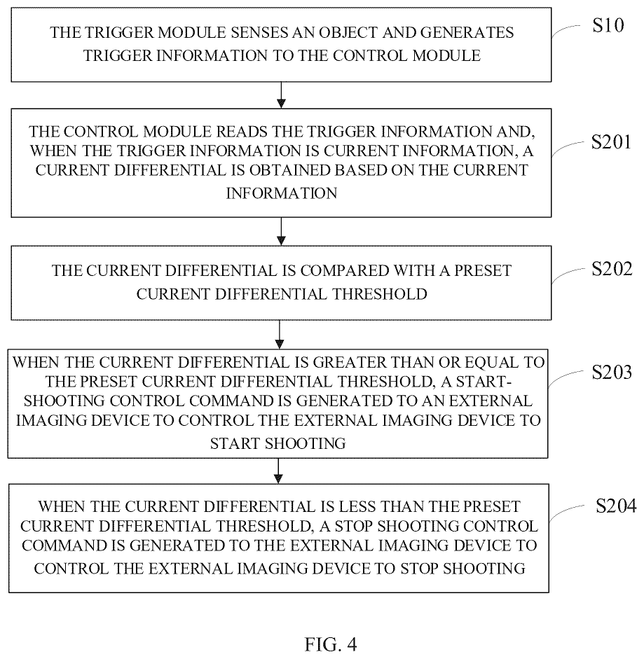

Referring to FIG. 4. FIG. 4 is a schematic flowchart of a second embodiment of the intelligent shooting control method of the present application.

Based on the first embodiment of the intelligent shooting control method, step S20 of the intelligent shooting control method in this embodiment specifically includes the following steps.

Step S201, the control module reads the trigger information, and when the trigger information is current information, a current differential is obtained based on the current information.

It should be noted that the control module can read the trigger information of the trigger module, including current information, specifically including the current when the trigger module is in standby and the present current of the trigger module, etc. The trigger information also includes the work information and level signal information of the trigger module during work. When the trigger information is current information, the current differential is calculated by calculating the standby current of the trigger module and the present current of the trigger module, so as to determine whether the trigger module is in the works state according to the current differential.

Step S202, the current differential is compared with a preset current differential threshold.

The preset current differential threshold can be set according to requirements. For example, the preset current differential threshold can be 275 mA, 400 mA, etc. This embodiment does not impose any limitation in this regard. The current differential refers to the current difference between the current of the trigger module in the standby state and the present current of the trigger module. By comparing the current differential with a preset current differential threshold, it is possible to determine whether the trigger module is in the work state.

Step S203, when the current differential is greater than or equal to the preset current differential threshold, a start-shooting command is generated to an external imaging device to control the external imaging device to start shooting.

In a specific embodiment, when the current differential is greater than or equal to the preset current differential threshold, it proves that the trigger module is working and has detected the presence of an object. A start-shooting command is then generated to the external imaging device, so that the external imaging device can be controlled to start shooting through the start-shooting command.

It is understandable that the shooting mode of the external imaging device cannot be switched by itself during shooting, and the control module can preset the shooting mode of the external imaging device, such as photo shooting or video recording. Then, after the step of generating a start-shooting command to the external imaging device to control the external imaging device to start shooting when the current differential is greater than or equal to the preset current differential threshold, the method further includes: retrieving the shooting mode; controlling the external imaging device to execute shooting according to the shooting mode; when the shooting mode is video recording, triggering a shutter of the external imaging device to start recording, and re-triggering the shutter to terminate recording when the current differential falls below the preset current differential threshold, thereby completing video recording; when the shooting mode is single photo shooting, triggering the shutter at intervals of a first preset period to complete single photo shooting; and when the shooting mode is continuous shooting, triggering the shutter at intervals of a second preset period for a preset continuous shooting duration to complete continuous shooting.

It should be noted that when shooting is required, the control module can retrieve the shooting mode stored in itself. The shooting mode can be a video recording mode, a single photo shooting mode, a continuous mode, etc., and can also include other modes, which are not limited in this embodiment. When the control module retrieves the shooting mode, it can control the external imaging device to execute shooting according to the shooting mode. When the shooting mode is the video recording mode, a lever can be set inside the control module. By switching the lever to a position of video recording, the camera module allows manual reassignment of the function of the video button to the shutter button. This enables triggering the shutter of the external imaging device to start recording via the connecting cable. When the current differential is less than the preset current differential threshold, no work information is read, or the level signal information of the preset level signal is not read, the trigger module does not detect the appearance of the object at this time, and it is necessary to control the external imaging device to stop recording, and then trigger the shutter of the external imaging device again to stop recording, thereby completing a video recording. When it is detected again that the current differential is greater than or equal to the preset current differential threshold, the work information is read, or the level signal information of the preset level signal is read, the shutter release of the external imaging device can be controlled again to perform the second video shooting, and so on.

In a specific embodiment, if the shooting mode is a single photo shooting mode, the shutter of the external imaging device is triggered to shoot the object every first preset period. The first preset period may be 1 s, 2 s, 5 s, etc. This embodiment does not impose any limitation in this regard. The interval period must ensure sufficient time for the flash of the external imaging device to complete charging and guarantee effective flash operation. When the current differential is less than the preset current differential threshold and no work information or no preset level signal information is read, and the trigger module stops sensing. The shutter of the external imaging device is not released until the current differential of the trigger module is detected again to be greater than or equal to the preset current differential threshold, the work information is read, or the signal information of the preset level signal is read. The shutter release of the external imaging device can be triggered again for a second photo shooting.

It should be understood that if the shooting mode is the continuous shooting mode, the shutter of the external imaging device is triggered at intervals of the second preset period to execute continuous shooting for a preset continuous shooting duration, so as to complete shooting in the continuous shooting mode. For example, the shutter of the external imaging device is triggered to start high-speed shooting, and the preset continuous shooting duration may be 1 second, 2 seconds, 5 seconds, etc. This embodiment does not impose any limitation in this regard. The second preset period may be 1 s, 2 s, 5 s, etc. This embodiment does not impose any limitation in this regard. The first preset period and the second preset period may be the same or different. When the first continuous shooting ends, the second high-speed continuous shooting is performed at intervals of the second preset period until the current differential is less than the preset current differential threshold, the work information is not read, or the level signal information of the preset level signal is not read, and the shutter is no longer released. When it is detected again that the current differential is greater than or equal to the preset current differential threshold, the work information is read, or the level signal information of the preset level signal is read, the shutter release of the external imaging device is triggered to perform the second cycle of continuous shooting.

Further, when the control module communicates wirelessly with the terminal, the control module is further configured to issue an alert to the terminal based on the start-shooting command, so that the terminal controls the external imaging device according to the alert.

It should be understood that the terminal can be a device such as a mobile phone or tablet computer. The control module and the terminal can be wirelessly connected via Bluetooth or Wi-Fi, so that the control module can send information to the terminal and also receive information sent by the terminal. For example, if the trigger information is current information, when the current differential is greater than or equal to a preset current differential threshold, the control module generates a start-shooting command to control the external imaging device to enter an automatic shooting state. At the same time, the control module generates an alert according to the start-shooting command and sends the alert to the terminal, prompting the terminal that an object has appeared at this time. The method of alerting can be vibration or voice prompt from the terminal. When the terminal receives the alert, the user can choose whether to control the external imaging device according to the alert. The user can operate on the operation interface of the terminal. For example, the user clicks to cancel automatic shooting and enters the manual operation state, and automatic shooting stops. If the user does not operate the interface of the terminal, continue to control the external imaging device for automatic shooting. The trigger information may also include level signal information. When the level signal information is a preset level signal, the control module generates a start-shooting command to control the external imaging device, and simultaneously generates an alert to the terminal. Alternatively, if the control module reads the work information of the write unit in the trigger module, it generates a start-shooting command to control the external imaging device, and simultaneously generates an alert to the terminal.

It should be noted that when the automatic shooting state is stopped, the terminal cannot restore the automatic shooting state of the external imaging device. After the user stops controlling the external imaging device, the external imaging device can enter the standby state. When the control module receives the trigger information again and determines that an object appears according to the trigger information, the external imaging device enters the automatic shooting state.

Step S204, when the current differential is less than the preset current differential threshold, a stop-shooting command is generated to the external imaging device to control the external imaging device to stop shooting.

In a specific embodiment, when the current differential is less than the preset current differential threshold, it proves that the trigger module has not detected an object at this time, that is, it is in a stop sensing state. Then, a stop-shooting command can be generated to the external imaging device to control the external imaging device to stop shooting, or a standby command can be generated to the external imaging device to control the external imaging device to stand by.

Specifically, after the step of controlling the external imaging device to stop shooting, the method further includes the following steps: acquiring a duration during which the current differential remains below the preset current differential threshold; and controlling the trigger module to stop detecting when the duration exceeds a preset detection time threshold.

The duration refers to the time that the trigger module does not detect an object, such as 10 s, 20 s, etc. The preset detection time threshold can be set to 15 s, 20 s, etc. When the duration is greater than the preset detection time threshold, to prevent unnecessary power consumption from continuous working of the trigger module, the trigger module can be controlled to stop sensing.

As shown in Table 1, which is a shooting mode table, the shooting modes include modes of shooting photo and recording video. The photo shooting mode includes single photo shooting mode and continuous shooting mode. The single photo shooting mode can be set to 1 photo, 2 photos, or 10 photos, etc., with shooting intervals of 1 second, 2 seconds, 5 seconds, etc. The continuous shooting mode can be set to continuous shooting durations of 2 seconds, 3 seconds, etc., and continuous shooting counts of 1 time, 2 times, 3 times, etc. The video recording mode can be set to record a video every 10 seconds, 30 seconds, or 3 minutes, etc. The above data settings can be adjusted by the user according to the shooting content and needs.

TABLE 1

| MODE | | SETTING INSTRUCTION |
|---|---|---|
| SHOOTING | SINGLE PHOTO | NUMBER OF SHOTS: 10; |
| PHOTO | SHOOTING | INTERVAL: 1 SECOND |
| | MODE | |
| | CONTINUOUS | DURATION: 2 SECONDS; |
| | SHOOTING | CONTINUOUS SHOOTING |
| | MODE | COUNT: 3 TIMES |
| RECORDING | VIDEO | 10-SEC, 30-SEC, OR 3-MIN PER |
| VIDEO | RECORDING | SEGMENT |
| | MODE | |

Further, a light sensing module can be connected to the control module to sense environmental information through the light sensing module and send the environmental information to the control module. When the environmental information indicates nighttime, the control module generates a sleep command to the external imaging device to control the external imaging device to sleep. It should be understood that the light sensing module can be a light intensity sensor, such as a photodiode, or other devices capable of sensing light intensity. This embodiment does not impose any limitation in this regard. The light sensing module senses external environmental information, specifically including daytime or nighttime information, and determines whether the current environment is daytime or nighttime by sensing the light intensity, and sends the environmental information to the control module. The light sensing module can be connected to the control module separately, or can be integrated inside the trigger module. This embodiment does not impose any limitation in this regard. When the environmental information indicates nighttime, the control module generates a sleep command to the external imaging device to control the external imaging device to sleep. At the same time, the control module itself enters the sleep state. At this time, the trigger module can continue to work, and the trigger module can be used as an independent camera to sense and shoot objects to obtain image data.

In this embodiment, a display device, such as a liquid crystal display screen, may also be provided outside the intelligent shooting control system. The display device is connected to the control module, and the sleep time of the control module 20 and the external imaging device is manually set on the display device and displayed on the display screen. When the set sleep time is reached, the control module generates a sleep command to the external imaging device according to the information obtained from the display device, controls the external imaging device to enter sleep mode, and the control module itself enters sleep mode.

In this embodiment, the external imaging device may include shooting equipment such as a digital camera and a video camera, and a full-color night vision camera. The control module is connected to the digital camera and the full-color night vision camera respectively. When the light sensing module senses that the environmental information is daytime, the control module generates a digital camera shooting command, and controls the digital camera to work according to the digital camera shooting command. At this time, the full-color night vision camera enters the sleep state. When the light sensing module senses that the environmental information is nighttime, the control module generates a full-color night vision camera shooting command, and controls the full-color night vision camera to work according to the full-color night vision camera shooting command. At this time, the digital camera enters the sleep state, so that uninterrupted shooting can be performed during the day and night, improving the shooting effect. The control module can also be used to generate a corresponding shooting command to the external imaging device according to the environmental information, to control the external imaging device to perform shooting. When the environmental information is nighttime (dark), the control module generates a digital camera shooting command to the digital camera to control the digital camera to shoot. When the environmental information is daytime (bright light), the control module generates a full-color night vision camera shooting command to the full-color night vision camera to control the full-color night vision camera to shoot.

In this embodiment, the control module reads the trigger information, when the trigger information is current information, obtains a current differential according to the current information and compares the current differential with a preset current differential threshold. When the current differential is greater than or equal to the preset current differential threshold, generates a start-shooting command to an external imaging device to control the external imaging device to start shooting. When the current differential is less than the preset current differential threshold, generates a stop-shooting command to the external imaging device to control the external imaging device to stop shooting. The current differential can be quickly calculated according to the read current information, so that the work state of the trigger module can be accurately and timely known, and the external imaging device can be conveniently and quickly controlled through the control module, improving the shooting and control effect.

It should be understood that the above is only illustrative and does not constitute any limitation to the technical solutions of this application. In specific applications, those skilled in the art can make settings as needed, and this application does not impose any restrictions on this.

It should be noted that the workflow described above is merely illustrative and does not constitute a limitation on the scope of protection of this application. In practical applications, those skilled in the art can select some or all of the steps to achieve the purpose of the present embodiment according to actual needs, which is not limited herein.

Furthermore, technical details not exhaustively described in this embodiment can be found in the intelligent shooting control method provided in any embodiment of this application, and will not be elaborated upon here.

Furthermore, it should be noted that, in this text, the terms “including”, “containing”, or any other variations thereof, are intended to encompass non-exclusive inclusion, such that a process, method, article, or system that includes a series of elements not only includes those elements but also includes other elements not explicitly listed, or elements inherent to such a process, method, article, or system. Without further limitations, an element qualified by the statement “including a . . . ” does not exclude the presence of additional identical elements in the process, method, article, or system that includes the element.

The aforementioned sequence numbers of the embodiments of the present application are merely for description and do not represent the superiority or inferiority of the embodiments.

Through the description of the above embodiments, those skilled in the art can clearly understand that the above embodiment methods can be implemented by means of software plus a necessary general-purpose hardware platform, and of course, it can also be implemented by hardware, but in many cases, the former is a better embodiment. Based on this understanding, the essence of the technical solution of this application, or the part that contributes to the prior art, can be embodied in the form of a software product, which is stored in a storage medium (such as Read Only Memory (ROM)/RAM, magnetic disk, optical disk), including several instructions to cause a terminal device (which may be a mobile phone, computer, server, or network device, etc.) to perform the method described in each embodiment of this application.

The above are merely some embodiments of this application and do not limit the patent scope of this application. Any equivalent structural or equivalent process transformations made using the content of this application's specification and drawings, or direct or indirect applications in other related technical fields, are similarly included within the patent protection scope of this application.

1. An intelligent shooting control system, wherein the intelligent shooting control system comprises a trigger module and a control module connected in sequence, wherein the control module is connected to an external imaging device;
the trigger module is configured to sense objects and generate trigger information to the control module; and
the control module is configured to read the trigger information and generate a corresponding command according to the trigger information to control the external imaging device.

2. The intelligent shooting control system according to claim 1, wherein the trigger information includes current information; when the trigger information is current information, the control module is configured to obtain a current differential based on the current information and compare the current differential with a preset current differential threshold; when the current differential is equal to or greater than the preset current differential threshold, the control module is configured to generate a start-shooting command to the external imaging device so as to control the external imaging device to start shooting; and
when the current differential is less than the preset current differential threshold, the control module is configured to generate a stop-shooting command is generated and transmitted to the external imaging device so as to control the external imaging device to terminate shooting.

3. The intelligent shooting control system as described in claim 2, wherein the control module and the external imaging device are connected via a connecting cable, the connecting cable comprised a shutter release cable and/or a USB data cable; and
the control module is further configured to retrieve a shooting mode and, based on the shooting mode and the start-shooting command, control the external imaging device via the shutter release cable and/or the USB data cable to perform video recording, single photo shooting, or continuous shooting.

4. The intelligent shooting control system according to claim 2, wherein the control module communicates wirelessly with a terminal; and
the control module is further configured to issue an alert to the terminal based on the start-shooting command, so that the terminal controls the external imaging device according to the alert.

5. The intelligent shooting control system according to claim 1, wherein the trigger module comprises a trigger unit, a main control unit, and a write unit connected in sequence, the main control unit and the write unit are respectively connected to the control module;
the trigger unit is configured to detect objects and generate sensing information to the main control unit; and
the main control unit is configured to generate trigger information to the write unit or the control module according to the sensing information; and the write unit is configured to write object information for storage according to the trigger information.

6. The intelligent shooting control system according to claim 5, wherein the trigger information includes work information, the work information is the information that the write unit writes to the object information based on the trigger information; and
the control module is further configured to generate a start-shooting command to the external imaging device according to the work information, so as to control the external imaging device to start shooting.

7. The intelligent shooting control system according to claim 1, wherein the trigger information includes level signal information; and the control module is further configured to generate a start-shooting command to the external imaging device when the level signal information is a preset level signal, so as to control the external imaging device to start shooting.

8. The intelligent shooting control system according to claim 1, wherein the trigger module comprises at least one of the following: a pyroelectric infrared sensor unit, an infrared thermal imaging sensor unit, a camera target recognition unit, an ultrasonic detection unit, or a radar detection unit.

9. The intelligent shooting control system according to claim 1, comprising a light sensing module connected to the control module;
wherein the optical sensing module is configured to sense environmental information and send the environmental information to the control module; and
the control module is further configured to generate a sleep command to the external imaging device when the environmental information indicates nighttime, so as to deactivate the external imaging device.

10. An intelligent shooting control method, applied to the intelligent shooting control system according to claim 1, the intelligent shooting control system comprising a trigger module and a control module, the method comprising the following steps:
the trigger module detecting an object and generating trigger information to the control module; and
the control module reading the trigger information and generating a corresponding command based on the trigger information to control external imaging device.

11. The intelligent shooting control method according to claim 10, wherein the step of the control module reading the trigger information and generating a corresponding command based on the trigger information to control external imaging device, comprises:
the control module reading the trigger information and calculating a current differential when the trigger information is current information;
comparing the current differential with a preset current differential threshold;
generating a start-shooting command to the external imaging device when the current differential is greater than or equal to the preset current differential threshold so as to start shooting; and
generating a stop-shooting command to the external imaging device when the current differential is less than the preset current differential threshold so as to terminate shooting.

12. The intelligent shooting control method according to claim 11, wherein after the step of generating a start-shooting command to the external imaging device when the current differential is greater than or equal to the preset current differential threshold so as to start shooting, the method further comprises:
retrieving the shooting mode;
controlling the external imaging device to execute shooting according to the shooting mode;
when the shooting mode is video recording, triggering a shutter of the external imaging device to start recording, and re-triggering the shutter to terminate recording when the current differential falls below the preset current differential threshold, thereby completing video recording;
when the shooting mode is single photo shooting, triggering the shutter at intervals of a first preset period to complete single photo shooting; and
when the shooting mode is continuous shooting, triggering the shutter at intervals of a second preset period for a preset continuous shooting duration to complete continuous shooting.

13. The intelligent shooting control method according to claim 11, wherein after the step of generating a stop-shooting command to the external imaging device when the current differential is less than the preset current differential threshold so as to terminate shootings, the method further comprises:
acquiring a duration during which the current differential remains below the preset current differential threshold; and
controlling the trigger module to stop detecting when the duration exceeds a preset detection time threshold.

14. An intelligent shooting control method for an intelligent shooting control system, wherein the intelligent shooting control system comprises a trigger module and a control module connected in sequence, and the control module is connected to an external imaging device; the method comprising the following steps:
the trigger module detecting an object and generating trigger information to the control module; and
the control module reading the trigger information and generating a corresponding command based on the trigger information to control external imaging device;
wherein the command comprises a start-shooting command and a stop-shooting command.

15. The intelligent shooting control method according to claim 14, wherein when the start-shooting command is generated to the external imaging device, the method further comprises the following steps:
retrieving a shooting mode of the external imaging device; and
controlling the external imaging device to execute shooting according to the shooting mode.

16. The intelligent shooting control method according to claim 15, wherein when the control module reads current information as the trigger information, the method further comprises the following steps:
the control module obtaining a current differential based on the current information, and comparing the current differential with a preset current differential threshold;
when the current differential is greater than or equal to the preset current differential threshold, the control module generating the start-shooting command to the external imaging device so as to control the external imaging device to start shooting; and
when the current differential is less than the preset current differential threshold, the control module generating the stop-shooting command to the external imaging device to control the external imaging device to stop shooting, or the control module generating a standby command to the external imaging device to control the external imaging device to standby.

17. The intelligent shooting control method according to claim 16, comprising the following steps:
acquiring a duration during which the current differential remains below the preset current differential threshold; and
controlling the trigger module to stop detecting when the duration exceeds a preset detection time threshold.

18. The intelligent shooting control method according to claim 16, wherein in the step of controlling the external imaging device to execute shooting according to the shooting mode,
when the shooting mode is video recording, triggering a shutter of the external imaging device to start recording, and re-triggering the shutter to terminate recording when the current differential falls below the preset current differential threshold, thereby completing video recording;
when the shooting mode is single photo shooting, triggering the shutter at intervals of a first preset period to complete single photo shooting; and
when the shooting mode is continuous shooting, triggering the shutter at intervals of a second preset period for a preset continuous shooting duration to complete continuous shooting.

19. The intelligent shooting control method according to claim 14, wherein when the control module reads level signal information as the trigger information, if the level signal information matches a preset level signal, the control module generates the start-shooting command to control the external imaging device; and the preset level signal is a high-level signal or a low-level signal.

20. The intelligent shooting control method according to claim 14, wherein the trigger information includes work information, which confirms that the trigger module is writing detected object information through a predefined writing protocol; the method further comprises the following steps:
if the control module reads work information, generating the start-shooting command to the external imaging device to control the external imaging device to start shooting;
if the control module does not read working information, generating the stop-shooting command to the external imaging device to controls the external imaging device to stop shooting.
